(19) United States
(12) Patent Application Publication
(10) Pub. No.: US 2003/0022989 A1
(43) Pub. Date: Jan. 30, 2003

(54) Impact-modified molding compositions of polyethylene terephthalate and dihydroxydiarylcyclohexane-based polycarbonate

(76) Inventors: Thomas Braig, Dusseldorf (DE); Detlev Joachimi, Krefeld (DE); Matthias Bienmuller, Krefeld (DE); Friedemann Paul, Bergisch Gladbach (DE)

Correspondence Address: BAYER CORPORATION, PATENT DEPARTMENT, 100 BAYER ROAD, PITTSBURGH, PA, 15205, US

(21) Appl. No.: 10/123,273

(22) Filed: Apr. 16, 2002

(30) Foreign Application Priority Data
Apr. 20, 2001 (DE) 10119681.4

(51) Int. Cl. C08L 51/00

(52) U.S. Cl. 525/67

(57) ABSTRACT

A thermoplastic molding composition containing A) polyethylene terephthalate, B) optional aromatic polycarbonate the molecular structure of which contains no units derived from dihydroxydiarylcycloalkanes, C) polycarbonate the molecular structure of which includes at least one unit derived from dihydroxydiarylcycloalkane, D) an elastomeric polymer and E) filler and/or reinforcing material is disclosed. The inventive composition features improved properties and is especially suitable for making exterior automotive parts.

### FIELD OF THE INVENTION

The present invention relates to the preparation and use of impact-modified polyethylene terephthalate/polycarbonate blends and more particularly to compositions wherein polycarbonate is based on dihydroxydiarylcycloalkane.

### SUMMARY OF THE INVENTION

A thermoplastic molding composition containing A) polyethylene terephthalate, B) optional aromatic polycarbonate the molecular structure of which contains no units derived from dihydroxydiarylcycloalkanes, C) polycarbonate the molecular structure of which includes at least one unit derived from dihydroxydiarylcycloalkane, D) an elastomeric polymer, and E) filler and/or reinforcing material is disclosed. The inventive composition features improved properties and is especially suitable for making exterior automotive parts.

### BACKGROUND OF THE INVENTION

Demands made of automotive body add-on parts of plastics are good toughness under impact and under a tensile load, in particular also at low temperatures, adequate rigidity, low thermal expansion, good flowability, good surface quality, good lacquerability with good adhesion of the lacquer, good chemical and fuel resistance. The molding compositions used must be suitable for the production of exterior automotive body parts.

Exterior automotive body parts of plastics generally have to be lacquered. In the case of plastics colored the color of the vehicle, the automotive body add-on parts produced therefrom are generally coated with one or more layers of transparent lacquers. In the case of plastics that are not colored the color of the vehicle, the automotive body add-on parts produced therefrom are lacquered with a plurality of lacquer layers, at least one of the layers imparting color. The applied lacquer layers must generally be baked and cured at elevated temperature. The required temperatures and temperature exposure times differ according to the lacquering process and the lacquer system used: for the so-called online process, in which the parts to be lacquered undergo cathodic dip-coating (CDC) together with the steel body, that temperature is typically about 165° C. to 180° C. For the so-called inline process, in which the parts to be lacquered are introduced into the body lacquering process after cathodic dip-coating of the steel body, the temperature is typically about 130° C. to 160° C. The plastics material of the automotive body add-on parts must, if possible, exhibit no changes, such as, for example, irreversible deformation, during the curing or baking. It is therefore necessary to provide thermoplastic polycarbonate molding compositions having improved dimensional stability under heat.

Practical experience shows that the properties of materials used for automotive body add-on body parts may vary widely according to the concrete field of use of the materials. However, the ultimate determining factor, which is very important for all materials, is adequate dimensional stability under heat to permit problem-free lacquering.

Filler-containing polycarbonate molding compositions, which contain semi-crystalline polyesters, graft copolymers and mineral fillers, are known. Such molding compositions are used, for example, in the automotive sector.

DE-A 19 753 541 discloses polycarbonate molding compositions which contain partially aromatic polyesters, graft copolymers and mineral fillers and which have adequate toughness for exterior automotive body parts. However, these molding compositions have inadequate dimensional stability under heat.

EP-A 135 904 describes polycarbonate molding compositions containing polyethylene terephthalate, polybutadiene-based graft copolymers, and talc in an amount of up to 4 wt. %. A favorable combination of properties of low warpage and high toughness is disclosed as an advantage.

In JP-A 08 176 339, polycarbonate molding compositions that contain talc as the mineral filler are described. ABS resins, polyethylene terephthalate and polybutylene terephthalate may be used as further blend partners. Good impact strength and surface quality are emphasized as being advantages of the molding compositions.

JP-A 07 025 241 describes polycarbonate molding compositions having high rigidity and good surface quality. The molding compositions contain from 60 to 70 wt. % polycarbonate, from 20 to 30 wt. % polyesters, from 5 to 10 wt. % acrylate rubber and from 5 to 10 wt. % talc, as well as from 0.1 to 1 part by weight (based on 100 parts of polymer components) of antioxidant.

JP-A 62 138 550 discloses polycarbonate molding compositions that contain polybutylene terephthalate polyesters, from 5 to 20 wt. % elastic copolymers and from 5 to 40 wt. % mineral fillers. JP-A 63 132 961 discloses comparable polycarbonate molding compositions that contain polybutylene terephthalate polyesters, from 3 to 20 wt. % elastic copolymers and from 0.3 to 40 wt. % mineral fillers, for applications in the automotive sector.

Application DE-A 199 12 987 discloses polycarbonate molding compositions that contain polyesters, graft copolymers and mineral fillers, but the dimensional stability under heat that is achieved is not greater than 140° C.

U.S. Pat. No. 5,376,736 describes polycarbonate molding compositions containing polyethylene terephthalate and a dihydroxydiphenylcyclohexane-based polycarbonate, for transparent blends.

EP-A 0 385 086 describes compositions of polyalkylene terephthalates, dihydroxydiphenylcyclohexane-based polycarbonates, and elastomers. This publication also shows that, with blends of polybutylene terephthalate, dihydroxydiphenylcyclohexane-based polycarbonates and elastomers, Vicat B dimensional stability under heat of 157° C. may be achieved only in combination with extremely poor toughness properties, and good toughness properties may be achieved only in compositions having Vicat B dimensional stability under heat of at most 142° C.

The object of the present invention was to provide polycarbonate molding compositions that exhibit excellent dimensional stability under heat and lacquerability, so that the molding compositions may be used also for lacquering processes at temperatures of from 130° C. to 160° C. and above, such as, for example, the inline process.

### DETAILED DESCRIPTION OF THE INVENTION

Surprisingly, it has now been found that compositions containing polyethylene terephthalate in combination with at least one polycarbonate based on at least one dihydroxydiarylcycloalkane derivative, impact modifiers and fillers have the required properties. In particular, such combinations exhibit markedly increased Vicat B dimensional stability under heat as compared with combinations of polyethylene terephthalates with bisphenol-A based polycarbonate, impact modifiers and fillers, or as compared with combinations of polybutylene terephthalate with bisphenol A-based polycarbonate, impact modifiers. The compositions according to the invention are therefore suitable, for example, especially for applications as exterior automotive body parts that are lacquered by processes entailing exposure to high temperatures, such as, for example, the inline lacquering process.

In particular, it has been found that compositions containing polyethylene terephthalate, impact modifiers, fillers in combination with at least one polycarbonate based on at least one dihydroxydiarylcycloalkane derivative, and at least one further polycarbonate that does not contain a dihydroxydiarylcycloalkane derivative, exhibit increased Vicat B dimensional stability under heat and very good toughness, in addition to the profile of requirements mentioned at the beginning, and accordingly are suitable, for example, especially for applications as exterior automotive body parts that are lacquered by processes in which a temperature load greater than from 130 to 160° C. occurs, such as, for example, the inline lacquering process.

The present invention accordingly provides polycarbonate molding compositions having Vicat B dimensional stability under heat (DIN ISO 306/B 120) above 145° C. The compositions according to the invention additionally exhibit an unexpectedly little decline in impact strength at low temperatures. The polycarbonate molding compositions also exhibit an excellent overall property profile for automotive body add-on parts of plastics in respect of the demands mentioned above.

The inventive composition comprise:

A) 4 to 80 parts by weight, preferably 10 to 60 parts by weight, particularly preferably 12 to 40 parts by weight, especially 9 to 29 parts by weight, of at least one polyethylene terephthalate,

B) 0 to 50 parts by weight, preferably 3 to 50 parts by weight, more preferably 4 to 43 parts by weight, particularly preferably 4 to 32 parts by weight, most preferably 5 to 27 parts by weight, of at least one aromatic polycarbonate that contains no structural units derived from dihydroxydiarylcycloalkanes,

C) 10 to 90 parts by weight, preferably 15 to 80 parts by weight, particularly preferably 20 to 60 parts by weight, especially 23 to 55 parts by weight, of at least one polycarbonate the structure of which includes at least one unit derived from dihydroxydiarylcycloalkane,

D) 1.5 to 35 parts by weight, preferably 3 to 25 parts by weight, particularly preferably 6 to 20 parts by weight, especially 8 to 17 parts by weight, of at least one elastomeric polymer,

E) 1.5 to 54 parts by weight, preferably 2.5 to 34 parts by weight, particularly preferably 3.5 to 28 parts by weight, especially 5 to 21 parts by weight, of at least one filler and/or reinforcing agent.

The compositions according to the invention may additionally contain further additives such as nucleating agents, stabilizers, lubricants and/or release agents, conductivity additives, fireproofing agents, pigments and/or colorants, etc..

It is preferred for the sum of the parts by weight of A-E and of the mentioned further additives to be 100.

According to the invention, the compositions contain as component A) a polyethylene terephthalate or a mixture of two or more different polyethylene terephthalates. Polyethylene terephthalates within the scope of the invention are derived from terephthalic acid (or its reactive derivatives) and one or more aliphatic or cycloaliphatic diols having at least one ethylene glycol unit in their molecular structure.

Preferred polyethylene terephthalates (also abbreviated hereinbelow to: PET) may be prepared from terephthalic acid (or its reactive derivatives) and aliphatic or cycloaliphatic diols having an ethylene glycol unit according to known methods (Kunststoff-Handbuch, Vol. VIII, p. 695 ff, Karl-Hanser-Verlag, Munich 1973).

Preferred polyethylene terephthalates contain at least 80 mol. %, preferably 90 mol. %, based on the dicarboxylic acid, of terephthalic acid radicals and at least 80 mol. %, preferably at least 90 mol. %, based on the diol component, of ethylene glycol radicals.

The preferred polyethylene terephthalates may contain, in addition to terephthalic acid radicals, up to 20 mol. % of radicals of other aromatic dicarboxylic acids having from 8 to 14 carbon atoms or aliphatic dicarboxylic acids having from 4 to 12 carbon atoms, preferably phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyethylene terephthalates may contain, in addition to ethylene glycol, up to 20 mol. % of other aliphatic diols having from 3 to 12 carbon atoms or cycloaliphatic diols having from 6 to 21 carbon atoms, for example 1,3-propanediol, 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol and -1,6,2-ethyl-1,3-hexanediol, 2,2-diethyl-1,3-propanediol, 2,5-hexanediol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(3-β-hydroxyethoxyphenyl)-propane and 2,2-bis-(4-hydroxypropoxyphenyl)-propane (DE-A 24 07 674, 24 07 776, 27 15 932). Polyethylene terephthalates may also contain up to 20 mol. % of ether or polyether structures.

The polyethylene terephthalates may be branched by the incorporation of relatively small amounts of tri- or tetra-hydric alcohols or tri- or tetra-basic carboxylic acid, such as are described, for example, in DE-A 19 00 270 and U.S. Pat. No. 3,692,744. Examples of preferred branching agents are trimesic acid, trimellitic acid, trimethylol-ethane and -propane and pentaerythritol. It is advisable to use not more than 1 mol. % of the branching agent, based on the acid component.

Preferred polyethylene terephthalates are also copolyesters, which are prepared from at least two acid components and/or from at least two alcohol components; particularly preferred copolyesters are poly-(ethylene glycol/1,4-butanediol) terephthalates.

Special preference is given to polyethylene terephthalates that have been prepared solely from terephthalic acid or its reactive derivatives (e.g. its dialkyl esters) and ethylene glycol.

The polyethylene terephthalates generally have an intrinsic viscosity of approximately from 0.3 to 1.5 dl/g, preferably from 0.4 to 1.3 dl/g, particularly preferably from 0.5 to 0.8 dl/g, in each case measured in phenol/o-dichlorobenzene (1:1 part by weight) at 25° C.

Special preference is given to rapidly crystallizing polyethylene terephthalates, that is to say polyethylene terephthalates that have crystallization times at 215° C., according to the DSC method for isothermal crystallization, of less than 15 minutes, preferably of less than 10 minutes and particularly preferably of less than 5 minutes.

Rapid crystallization of the polyethylene terephthalates according to the invention is preferably achieved by addition of crystallizing agents to the polyethylene terephthalate during its preparation or subsequently thereto, for example by mixing them into the polyethylene terephthalate melt. There are preferably used as crystallizing agents metal salts of organic carboxylic acids, such as, for example, alkali metal or alkaline earth metal salts of benzoic acid or substituted benzoic acid.

A portion of the polyethylene terephthalate may be replaced by other thermoplastic polyesters, preferably polybutylene terephthalate. In general, up to 50 wt. %, preferably up to 10 wt. % (based on polyethylene terephthalate) of the polyethylene terephthalate may be replaced by other thermoplastic polyesters, preferably polyalkylene terephthalates.

Thermoplastic polyesters are reaction products of aromatic dicarboxylic acid or its reactive derivatives (e.g. dimethyl esters or anhydrides) and aliphatic, cycloaliphatic or araliphatic diols, and mixtures of those reaction products.

Preferred further thermoplastic polyesters are polyalkylene terephthalates which can be prepared from terephthalic acid (or its reactive derivatives) and aliphatic or cycloaliphatic diols having from 3 to 10 carbon atoms according to known methods (Kunststoff-Handbuch, Vol. VIII, p. 695 ff, Karl-Hanser-Verlag, Munich 1973).

Preferred polyalkylene terephthalates contain at least 80 mol. %, preferably 90 mol. %, based on the dicarboxylic acid, of terephthalic acid radicals and at least 80 mol. %, preferably at least 90 mol. %, based on the diol component, of 1,4-butanediol radicals.

The preferred polyalkylene terephthalates may contain, in addition to terephthalic acid radicals, up to 20 mol. % of radicals of other aromatic dicarboxylic acids having from 8 to 14 carbon atoms or aliphatic dicarboxylic acids having from 4 to 12 carbon atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, in addition to 1,4-butanediol glycol radicals, up to 20 mol. % of other aliphatic diols having from 3 to 12 carbon atoms or cycloaliphatic diols having from 6 to 21 carbon atoms, for example radicals of 1,3-propanediol, 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol and -1,6,2-ethyl-1,3-hexanediol, 2,2-diethyl-1,3-propanediol, 2,5-hexanediol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(3-β-hydroxyethoxyphenyl)-propane and 2,2-bis-(4-hydroxypropoxyphenyl)-propane (DE-A 24 07 674, 24 07 776, 27 15 932).

The polyalkylene terephthalates may—as has already been described above—likewise be branched by the incorporation of relatively small amounts of tri- or tetra-hydric alcohols or tri- or tetra-basic carboxylic acid.

Special preference is given to polyalkylene terephthalates that have been prepared solely from terephthalic acid and its reactive derivatives (e.g. its dialkyl esters) and 1,4-butanediol (polybutylene terephthalate).

Preferred polyalkylene terephthalates are also copolyesters, which are prepared from at least two of the above-mentioned acid components and/or from at least two of the above-mentioned alcohol components.

The polyalkylene terephthalates have an intrinsic viscosity of approximately from 0.3 to 1.5 dl/g, preferably from 0.4 to 1.3 dl/g, in each case measured in phenol/o-dichlorobenzene (1:1 part by weight) at 25° C.

According to the invention, the compositions according to the invention contain as component B a polycarbonate or a mixture of polycarbonates, none of which include structural units derived from dihydroxydiarylcycloalkane.

Preferred polycarbonates are homopolycarbonates and copolycarbonates based on the bisphenols of the general formula (I)

HO—Z—OH (I)

wherein Z is a divalent organic radical, having from 6 to 30 carbon atoms, which contains one or more aromatic groups.

Preference is given to bisphenols of formula (Ia)

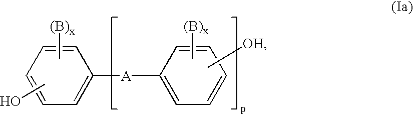

wherein

A is a single bond, C₁-C₅-alkylene, C₂-C₅-alkylidene, C₅-C₆-cycloalkylidene, —O—, —SO—, —CO—, —S—, —SO₂—, C₆-C₁₂-arylene, to which further aromatic rings optionally containing hetero atoms may be condensed,

or is a radical of formula (II) or (III)

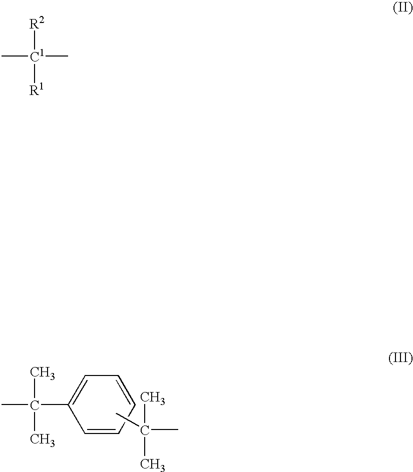

B is in each case C₁-C₁₂-alkyl, preferably methyl, halogen, preferably chlorine and/or bromine,

the number of substituents, x, are independent one of the others and are 0, 1 or 2,

p is 1 or 0, and

R¹ and R² are selected individually for each C¹ and are each independent one of the other, hydrogen or C₁-C₆-alkyl, preferably hydrogen, methyl or ethyl.

Polycarbonates that include structural units derived from dihydroxydiarylcycloalkanes are excluded for component B.

Examples of bisphenols according to the general formula (I) are bisphenols belonging to the following groups: dihydroxydiphenyls, bis-(hydroxphenyl)-alkanes, indane bisphenols, bis-(hydroxyphenyl) sulfides, bis-(hydroxyphenyl) ethers, bis-(hydroxyphenyl) ketones, bis-(hydroxyphenyl)-sulfones, bis-(hydroxyphenyl) sulfoxides and α,α′-bis-(hydroxyphenyl)-diisopropylbenzenes.

Derivatives of the mentioned bisphenols, which are obtainable, for example, by alkylation or halogenation at the aromatic rings of the mentioned bisphenols, are also examples of bisphenols according to the general formula (I).

Examples of bisphenols according to the general formula (I) are especially the following compounds: hydroquinone, resorcinol, 4,4′-dihydroxydiphenyl, bis-(4-hydroxyphenyl) sulfide, bis-(4-hydroxphenyl)-sulfone, bis-(3,5-dimethyl-4-hydroxyphenyl)-methane, bis-(3,5-dimethyl-4-hydroxyphenyl)-sulfone, 1,1-bis-(3,5-dimethyl-4-hydroxyphenyl)-p/m-diisopropylbenxene, 1,1-bis-(4-hydroxyphenyl)-1-phenylethane, 2,2-bis-(3,5-dichloro-4-hydroxyphenyl)-propane, 2,2-bis-(3methyl-4-hydroxyphenyl)-propane, 2,2-bis-(3,5-dimethyl-4-hydroxyphenyl)-propane, 2,2-bis-(4-hydroxyphenyl)-propane (i.e. bisphenol A), 2,2-bis-(3-chloro4-hydroxyphenyl)-propane, 2,2-bis-(3,5-dibromo-4-hydroxyphenyl)-propane, 2,4-bis-(4-hydroxyphenyl)-2-methylbutane, 2,4-bis-(3,5-dimethyl-4-hydroxyphenyl)-2-methylbutane, α,α′-bis-(4-hydroxyphenyl)-o-diisopropylbenzene, α,α′-bis-(4-hydroxyphenyl)-m-diisopropylbenzene (i.e. bisphenol M), α,α′-bis-(4-hydroxyphenyl)-p-diisopropylbenzene and indane bisphenol.

Particularly preferred polycarbonates B) are the homopolycarbonate based on bisphenol A.

The described bisphenols according to the general formula (I) may be prepared according to known processes, for example from the corresponding phenols and ketones.

The mentioned bisphenols and processes for their preparation are described, for example, in the monograph H. Schnell, “Chemistry and Physics of Polycarbonates”, Polymer Reviews, Volume 9, p. 77-98, Interscience Publishers, New York, London, Sydney, 1964, and in U.S Pat. No. 3,028,635, in U.S. Pat. No. 3,062,781, in U.S. Pat. No. 2,999,835, in U.S. Pat. No. 3,148,172, in U.S. Pat. No. 2,991,273, in U.S. Pat. No. 3,271,367, in U.S. Pat. No. 4,982,014, in U.S. Pat. No. 2,999,846, in DE-A 1 570 703, in DE-A 2 063 050, in DE-A 2 036 052, in DE-A 2 211 956, in DE-A 3 832 396 and in FR-A 1 561 518, as well as in Japanese Offenlegungsschrift JP-A 62039, JP-A 62040 and JP-A 105550 (1986) all incorporated herein by reference.

1,1-Bis-(4-hydroxyphenyl)-3,3,5-trimethylcyclohexane and its preparation are described, for example, in U.S. Pat. No. 4,982,014, incorporated herein by reference.

Indane bisphenols and their preparation are described, for example, in U.S. Pat. No. 3,288,864, in JP-A 60 035 150 and in U.S. Pat. No. 4,334,106, all incorporated herein by reference. Indane bisphenols may be prepared, for example, from isopropenylphenol or its derivatives or from dimers of isopropenylphenol or its derivatives in the presence of a Friedel-Craft catalyst in organic solvents.

Polycarbonates may be prepared according to known processes. Suitable processes for the preparation of polycarbonates are, for example, preparation from bisphenols with phosgene according to the phase boundary process or from bisphenols with phosgene according to the process in homogeneous phase, the so-called pyridine process, or from bisphenols with carbonic acid esters according to the melt transesterification process. Those preparation processes are described, for example, in H. Schnell, “Chemistry and Physics of Polycarbonates”, Polymer Reviews, Volume 9, p. 31-76, lnterscience Publishers, New York, London, Sydney, 1964. The mentioned preparation processes are also described in D. Freitag, U. Grigo, P. R. Müller, H. Nouvertne, “Polycarbonates” in Encyclopedia of Polymer Science and Engineering, Volume 11, Second Edition, 1988, pages 648 to 718 and in U. Grigo, K. Kircher and P. R. Müller “Polycarbonate” in Becker, Braun, Kunststoff-Handbuch, Volume 3/1, Polycarbonate, Polyacetale, Polyester, Celluloseester, Carl Hanser Verlag Munich, Vienna 1992, pages 117 to 299 and in D. C. Prevorsek, B. T. Debona and Y. Kesten, Corporate Research Center, Allied Chemical Corporation, Morristown, N.J. 07960, “Synthesis of Poly(estercarbonate) Copolymers” in Journal of Polymer Science, Polymer Chemistry Edition, Vol.19, 75-90 (1980) all incorporated herein by reference.

The melt transesterification process is described in particular in H. Schnell, “Chemistry and Physics of Polycarbonates”, Polymer Reviews, Volume 9, p. 44 to 51, Interscience Publishers, New York, London, Sydney, 1964 and in DE-A 1 031 512, in U.S. Pat. No. 3,022,272, in U.S. Pat. No. 5,340,905, and in U.S. Pat. No. 5,399,659, all incorporated herein by reference.

In the preparation of polycarbonate, raw materials and auxiliary substances having a low degree of impurities are preferably used. In the case of preparation according to the melt transesterification process in particular, the bisphenols used and the carbonic acid derivatives used should be as free as possible of alkali ions and alkaline earth ions. Raw materials of such purity are obtainable, for example, by recrystallizing, washing or distilling the carbonic acid derivatives, for example carbonic acid esters, and the bisphenols.

The polycarbonates that are suitable according to the invention preferably have a weight-average molecular weight (\overline{M}_{w}), determined, for example, by ultracentrifugation or scattered-light measurement, of 10,000 to 200,000 g/mol.. Particularly preferably, they have a weight-average molecular weight of 12,000 to 80,000 g/mol., especially preferably 20,000 to 35,000 g/mol..

The molecular weight of the polycarbonates according to the invention may be attained for example, in a known manner by means of an appropriate amount of chain terminators. The chain terminators may be used individually or in the form of a mixture of different chain terminators.

Suitable chain terminators include both monophenols and monocarboxylic acids. Suitable monophenols are, for example, phenol, p-chlorophenol, p-tert-butylphenol, cumylphenol or 2,4,6-tribromophenol, as well as long-chain alkylphenols, such as, for example, 4-(1,1,3,3-tetramethylbutyl)-phenol, or monoalkylphenols or dialkylphenols having a total of from 8 to 20 carbon atoms in the alkyl substituents, such as, for example, 3,5-di-tert-butylphenol, p-tert-octylphenol, p-dodecylphenol, 2-(3,5-dimethyl-heptyl)-phenol or 4-(3,5-dimethyl-heptyl)-phenol. Suitable monocarboxylic acids are benzoic acid, alkylbenzoic acids and halobenzoic acids.

Preferred chain terminators are phenol, p-tert-butylphenol, 4-(1,1,3,3-tetramethylbutyl)-phenol and cumylphenol.

The amount of chain terminators is preferably from 0.25 to 10 mol. %, based on the sum of the bisphenols used in a particular case.

The polycarbonates that are suitable according to the invention may be branched in a known manner, preferably by the incorporation of branching agents having a functionality of three or more than three.

Suitable branching agents are, for example, those having three or more than three phenolic groups or those having three or more than three carboxylic acid groups.

Suitable branching agents are, for example, phloroglucinol, 4,6-dimethyl-2,4,6-tri-(4-hydroxyphenyl)-hept-2-ene, 4,6-dimethyl-2,4,6-tri-(4-hydroxphenyl)-heptane, 1,3,5-tri-(4-hydroxyphenyl)-benzene, 1,1,1-tris-(4-hydroxyphenyl)-ethane, tri-(4-hydroxyphenyl)-phenylmethane, 2,2-bis-[4,4-bis-(4-hydroxyphenyl)-cyclohexyl]-propane, 2,4-bis-(4-hydroxyphenyl-isopropl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4- hydroxphenyl-isopropyl)-phenyl)-terephthalic acid ester, tetra-(4-hydroxyphenyl)-methane, tetra-(4-(4-hydroxyphenyl-isopropyl)-phenoxy)-methane and 1,4-bis-(4′, 4″-dihydroxytriphenyl)-methylbenzene, as well as 2,4-dihydroxybenzoic acid, trimesic acid, cyanuric chloride, 3,3-bis-(3-methyl-4-hydroxyphenyl)-2-oxo-2,3-dihydroindole, trimesic acid trichloride and α,α′,α″-tris-(4-hydroxyphenol)-1,3,5-triisopropylbenzene.

Preferred branching agents are 1,1,1-tris-(4-hydroxyphenyl)-ethane and 3,3-bis-(3-methyl-4-hydroxyphenyl)-2-oxo-2,3-dihydroindole.

The amount of branching agents that may optionally be used is preferably 0.05 mol. % to 2 mol. %, based on moles of bisphenols used.

The branching agents may be, for example in the case of the preparation of the polycarbonate according to the phase boundary process, placed in the aqueous alkaline phase with the bisphenols and the chain terminators, or they may be added, dissolved in an organic solvent, together with the carbonic acid derivatives. In the case of the transesterification process, the branching agents are preferably metered in together with the dihydroxy aromatic compounds or bisphenols.

Catalysts that are preferably to be used in the preparation of polycarbonate according to the melt transesterification process are the ammonium salts and phosphonium salts known in the literature (see, for example, U.S. Pat. No. 3,442,864, JP-A-14742/72, U.S. Pat. No. 5,399,659, and DE-A 19 539 290).

Copolycarbonates may also be used. Copolycarbonates within the scope of the invention are especially polydiorganosiloxane-polycarbonate block copolymers, whose weight-average molecular weight (\overline{M}_{w}) is preferably 10,000 to 200,000 g/mol., particularly preferably 20,000 to 80,000 g/mol. (determined by gel chromatography after previous calibration by light-scattering measurement or ultracentrifugation). The content of aromatic carbonate structural units in the polydiorganosiloxane-polycarbonate block copolymers is preferably from 75 to 97.5 wt. %, particularly preferably from 85 to 97 wt. %. The content of polydiorganosiloxane structural units in the polydiorganosiloxane-polycarbonate block copolymers is preferably from 25 to 2.5 wt. %, particularly preferably from 15 to 3 wt. %. The polydiorganosiloxane-polycarbonate block copolymers may be prepared, for example, starting from polydiorganosiloxanes containing α,ω-bishydroxyaryloxy end groups and having a mean degree of polymerization, Pₙ, of preferably 5 to 100, particularly preferably 20 to 80.

The polydiorganosiloxane-polycarbonate block copolymers may also be a mixture of polydiorganosiloxane-polycarbonate block copolymers with conventional polysiloxane-free, thermoplastic polycarbonates, the total content of polydiorganosiloxane structural units in that mixture preferably being 2.5 to 25 wt. %.

Such polydiorganosiloxane-polycarbonate block copolymers are characterized in that they contain in the polymer chain on the one hand aromatic carbonate structural units (1) and on the other hand polydiorganosiloxanes containing aryloxy end groups (2)

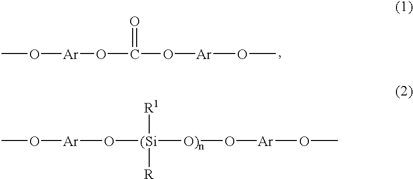

wherein the substituents Ar are identical or different difunctional aromatic radicals and

R and R¹ are identical or are different one from the others and represent linear alkyl, branched alkyl, alkenyl, halogenated linear alkyl, halogenated branched alkyl, aryl or halogenated aryl, preferably methyl, and

n represents the mean degree of polymerization of preferably from 5 to 100, particularly preferably from 20 to 80.

Alkyl in the above formula (2) is preferably C₁-C₂₀-alkyl; alkenyl in the above formula (2) is preferably C₂-C₆-alkenyl; aryl in the above formula (2) is preferably C₆-C₁₄-aryl. Halogenated in the above formula means partially or completely chlorinated, brominated or fluorinated.

Examples of alkyls, alkenyls, aryls, halogenated alkyls and halogenated aryls are methyl, ethyl, propyl, n-butyl, tert-butyl, vinyl, phenyl, naphthyl, chloromethyl, perfluorobutyl, perfluorooctyl and chlorophenyl.

Such polydiorganosiloxane-polycarbonate block copolymers and their preparation are described, for example, in U.S. Pat. No. 3,189,662, U.S. Pat. No. 3,821,325 and U.S. Pat. No. 3,832,419.

Preferred polydiorganosiloxane-polycarbonate block copolymers may be prepared, for example, by reacting polydiorganosiloxanes containing α,ω-bishydroxyaryloxy end groups together with other bisphenols, optionally with the concomitant use of branching agents in the conventional amounts, for example according to the two-phase boundary process (as described, for example, in H. Schnell, “Chemistry and Physics of Polycarbonates”, Polymer Reviews, Volume 9, p. 31-76, Interscience Publishers, New York, London, Sydney, 1964). The polydiorganosiloxanes containing α,ω-bishydroxyaryloxy end groups used as starting materials for that synthesis, and their preparation, are described, for example, in U.S. Pat No. 3,419,634.

Conventional additives, such as, for example, release agents, may be mixed with the polycarbonates in the melt or applied to the surface thereof. The polycarbonates used preferably already contain release agents before they are compounded with the other components of the molding compositions according to the invention.

According to the invention, the compositions contain as component C a polycarbonate or a mixture of polycarbonates.

Component C) differs from component B) according to the invention in that the basis of the component C) polycarbonate includes at least one structural unit derived from dihydroxydiarylcycloalkane (IV)

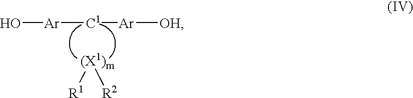

preferably a dihydroxydiphenylcycloalkane (IVa)

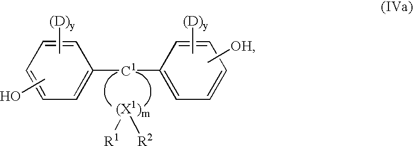

particularly preferably a di(para-hydroxyphenyl)cycloalkane (IVb)

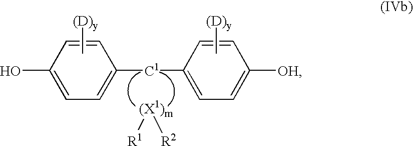

wherein

the substituents Ar are aromatic units or arylenes that are substituted or are unsubstituted, preferably phenylenes or naphthylenes, particularly preferably phenylenes, most preferably para-phenylenes, the optional substituents include alkyl groups and halogens,

R¹ and R² are selected individually for each X¹ and are each independently one of the other hydrogen or C₁-C₆-alkyl, preferably hydrogen, methyl or ethyl,

X¹ is carbon,

D is in each case C₁-C₁₂-alkyl, preferably methyl, halogen, preferably chlorine and/or bromine,

the number of substituents, y, independently one of the others are 0, 1, 2, 3 or 4, preferably 0, 1 or 2, particularly preferably 0,

m is an integer of 4 to 7, preferably 4 or 5, with the proviso that R¹ and R² are simultaneously alkyl on at least one atom X¹.

According to the invention it is also possible to use as the basis for the polycarbonate of component C) mixtures of one or more of the above-described dihydroxydiarylcycloalkanes (general formula (IV)) with one or more bisphenols of the general formula (I) as described for component B), so that there result therefrom according to the invention copolycarbonates that include at least one diarylenecycloalkane unit. According to the invention, polycarbonates of component C) may also be block copolycarbonates containing polycarbonate blocks, which are based on dihydroxydiarylcycloalkanes (general formula (IV)) or on copolycarbonates having a basis including dihydroxydiarylcycloalkanes, and polycarbonate blocks based on bisphenols of the general formula (I).

Component C) is particularly preferably a polycarbonate based on at least one dihydroxydiphenylcycloalkane having 5 or 6 ring carbon atoms in the cycloaliphatic radical (m=4 or 5 in formula (IVb)), such as, for example, the diphenols of formulae

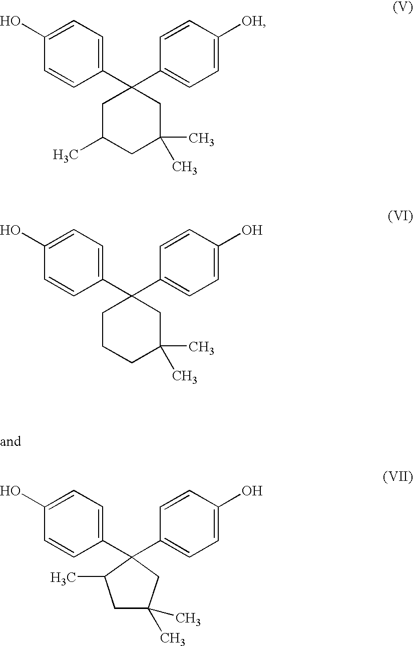

with 1,1-bis-(4-hydroxyphenyl)-3,3,5-trimethylcyclohexane (formula V) being particularly preferred.

Particularly preferred polycarbonates as component C) are the homopolycarbonate based on 1,1-bis-(4-hydroxyphenyl)-3,3,5-trimethylcyclohexane (formula V). The copolycarbonates based on bisphenol A and 1,1-bis-(4-hydroxyphenyl)-3,3,5-trimethylcyclohexane (formula V) are most preferred.

The (co)polycarbonates of component C) preferably have dimensional stability under heat, determined as Vicat B, of 150 to 260° C., particularly preferably 155 to 245° C., especially preferably 167 to 230° C. and most preferably 181 to 206° C.

Component C) according to the invention and its preparation, as well as the preparation of the dihydroxydiarylcycloalkanes, for example from the corresponding phenols and ketones, are described in detail, for example, in EP-A 0 359 953 and EP-A 0 4698 404. 1,1-Bis-(4-hydroxyphenyl)-3,3,5-trimethylcyclohexane (formula V) and its preparation are described, for example, in U.S. Pat. No. 4,982,014, or EP-A 0 359 953 all incorporated herein by reference.

The preparation of the bisphenols according to the general formula (I) described as comonomers has already been carried out in the description of component B).

(Co)polycarbonates of component C) may be prepared according to known processes. Suitable processes for the preparation of polycarbonates are, for example, preparation from bisphenols with phosgene according to the phase boundary process or from bisphenols with phosgene according to the process in homogeneous phase, the so-called pyridine process, or from bisphenols with carbonic acid esters according to the melt transesterification process. Those preparation processes are described, for example, in H. Schnell, “Chemistry and Physics of Polycarbonates”, Polymer Reviews, Volume 9, p. 31-76, Interscience Publishers, New York, London, Sydney, 1964. The mentioned preparation processes are also described in D. Freitag, U. Grigo, P. R. Müller, H. Nouvertne, “Polycarbonates” in Encyclopedia of Polymer Science and Engineering, Volume 11, Second Edition, 1988, pages 648 to 718 and in U. Grigo, K. Kircher and P. R. Müller “Polycarbonate” in Becker, Braun, Kunststoff-Handbuch, Volume 3/1, Polycarbonate, Polyacetale, Polyester, Celluloseester, Carl Hanser Verlag Munich, Vienna 1992, pages 117 to 299 and in D. C. Prevorsek, B. T. Debona and Y. Kesten, Corporate Research Center, Allied Chemical Corporation, Morristown, N.J. 07960, “Synthesis of Poly(estercarbonate) Copolymers” in Journal of Polymer Science, Polymer Chemistry Edition, Vol.19, 75-90 (1980), all incorporated herein by reference.

The melt transesterification process is described in particular in H. Schnell, “Chemistry and Physics of Polycarbonates”, Polymer Reviews, Volume 9, p. 44 to 51, Interscience Publishers, New York, London, Sydney, 1964 and in DE-A 1 031 512, in U.S. Pat. No. 3,022,272, in U.S. Pat. No. 5,340,905, and in U.S. Pat. No. 5,399,659, all incorporated herein by reference.

In the preparation of (co)polycarbonate of component C), raw materials and auxiliary substances having a low degree of impurities are preferably used. In the case of preparation according to the melt transesterification process in particular, the bisphenols used and the carbonic acid derivatives used should be as free as possible of alkali ions and alkaline earth ions. Raw materials of such purity are obtainable, for example, by recrystallizing, washing or distilling the carbonic acid derivatives, for example carbon acid esters, and the bisphenols.

The (co)polycarbonates of component C) that are suitable according to the invention preferably have a weight-average molecular weight (+E,ovs,M_{w}), which may be determined, for example, by ultracentrifugation, scattered-light measurement or gel permeation chromatography after previous calibration, of over 10,000 g/mol., preferably 10,000 to 300,000 g/mol.. Particularly preferably, they have a weight-average molecular weight of 12,000 to 80,000 g/mol., especially preferably 20,000 to 38,000 g/mol..

The molecular weight of the (co)polycarbonates of component C) according to the invention may be established, for example, in a known manner by means of an appropriate amount of chain terminators. The chain terminators may be used individually or in the form of a mixture of different chain terminators.

Suitable chain terminators are both monophenols and monocarboxylic acids. Suitable monophenols are, for example, phenol, p-chlorophenol, p-tert-butylphenol, cumylphenol or 2,4,6-tribromophenol, as well as long-chain alkylphenols, such as, for example, 4-(1,1,3,3-tetramethylbutyl)-phenol, or monoalkylphenols or dialkylphenols having a total of from 8 to 20 carbon atoms in the alkyl substituents, such as, for example, 3,5-di-tert-butylphenol, p-tert-octylphenol, p-dodecylphenol, 2-(3,5-dimethyl-heptyl)-phenol or 4-(3,5-dimethyl-heptyl)-phenol. Suitable monocarboxylic acids are benzoic acid, alkylbenzoic acids and halobenzoic acids.

Preferred chain terminators are phenol, p-tert-butylphenol, 4-(1,1,3,3-tetramethylbutyl)-phenol and cumylphenol.

The amount of chain terminators is preferably from 0.25 to 10 mol. %, based on the sum of the bisphenols used in a particular case.

The polycarbonates of component C) that are suitable according to the invention may be branched in a known manner, preferably by the incorporation of branching agents having a functionality of three or more than three. Suitable branching agents are, for example, those having three or more than three phenolic groups or those having three or more than three carboxylic acid groups.

Suitable branching agents are, for example, phloroglucinol, 4,6-dimethyl-2,4,6-(tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tris-(4-hydroxyphenyl)-ethane, tri-(4-hydroxyphenyl)-phenylmethane, 2,2-bis-[4,4-bis-(4-hydroxyphenyl)-cyclohexyl]-propane, 2,4-bis-(4-hydroxyphenyl-isopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)-phenyl)-terephthalic acid ester, tetra-(4-hydroxphenyl)-methane, tetra-(4-(4-hydroxyphenyl-isopropyl)-phenoxy)-methane and 1,4-bis-(4′,4″-dihydroxytriphenyl)-methylbenzene, as well as 2,4-dihydroxybenzoic acid, trimesic acid, cyanuric chloride, 3,3-bis-(3-methyl-4-hydroxyphenyl)-2-oxo-2,3-dihydroindole, trimesic acid trichloride and α,α′,α″-tris-(4-hydroxyphenol)-1,3,5-triisopropylbenzene.

Preferred branching agents are 1,1,1-tris-(4-hydroxyphenyl)-ethane and 3,3-bis-(3-methyl4-hydroxyphenyl)-2-oxo-2,3-dihydroindole.

The amount of branching agents that may optionally be used is preferably 0.05 mol. % to 2 mol. %, based on moles of bisphenols used.

The branching agents may, for example in the case of the preparation of the (co)polycarbonate of component C) according to the phase boundary process, be placed in the aqueous alkaline phase with the bisphenols and the chain terminators, or they may be added, dissolved in an organic solvent, together with the carbonic acid derivatives. In the case of the transesterification process, the branching agents are preferably metered in together with the dihydroxy aromatic compounds or bisphenols.

Catalysts that are preferably to be used in the preparation of polycarbonate according to the melt transesterification process are the ammonium salts and phosphonium salts known in the literature (see, for example, U.S. Pat. No. 3,442,864, JP-A-14742/72, U.S. Pat. No. 5,399,659, and DE-A 19 539 290).

Copolycarbonates may also be used. Copolycarbonates within the scope of the invention for component C) are especially polydiorganosiloxane-polycarbonate block copolymers, whose weight-average molecular weight (\overline{M}_{w}) is preferably 10,000 to 200,000 g/mol., particularly preferably 20,000 to 80,000 g/mol. (determined by gel chromatography after previous calibration by light-scattering measurement or ultracentrifugation). The content of aromatic carbonate structural units in the polydiorganosiloxane-polycarbonate block copolymers is preferably 75 to 97.5 wt. %, particularly preferably 85 to 97 wt. %. The content of polydiorganosiloxane structural units in the polydiorganosiloxane-polycarbonate block copolymers is preferably 25 to 2.5 wt. %, particularly preferably 15 to 3 wt. %. The polydiorganosiloxane-polycarbonate block copolymers may be prepared, for example, starting from polydiorganosiloxanes containing α,ω-bishydroxyaryloxy end groups and having a mean degree of polymerization, Pₙ, of preferably 5 to 100, particularly preferably 20 to 80.

The polydiorganosiloxane-polycarbonate block copolymers may also be a mixture of polydiorganosiloxane-polycarbonate block copolymers with conventional polysiloxane-free, thermoplastic polycarbonates, the total content of polydiorganosiloxane structural units in that mixture preferably being from 2.5 to 25 wt. %.

Such polydiorganosiloxane-polycarbonate block copolymers are characterized in that they contain in the polymer chain on the one hand aromatic carbonate structural units (1) and on the other hand polydiorganosiloxanes containing aryloxy end groups (2)

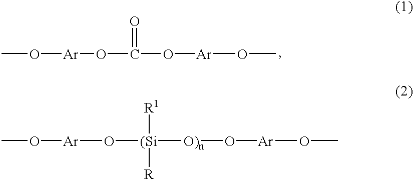

wherein

the substituents Ar independently one of the others are difunctional aromatic radicals and

R and R¹ are identical or are different one from the other and represent linear alkyl, branched alkyl, alkenyl, halogenated linear alkyl, halogenated branched alkyl, aryl or halogenated aryl, preferably methyl, and

n represents the mean degree of polymerization of preferably 5 to 100, particularly preferably 20 to 80.

Alkyl in the above formula (2) is preferably C₁-C₂₀-alkyl; alkenyl in the above formula (2) is preferably C₂-C₆-alkenyl; aryl in the above formula (2) is preferably C₆-C₁₄-aryl. Halogenated in the above formula means partially or completely chlorinated, brominated or fluorinated.

Examples of alkyls, alkenyls, aryls, halogenated alkyls and halogenated aryls are methyl, ethyl, propyl, n-butyl, tert-butyl, vinyl, phenyl, naphthyl, chloromethyl, perfluorobutyl, perfluorooctyl and chlorophenyl.

Such polydiorganosiloxane-polycarbonate block copolymers and their preparation are described, for example, in U.S. Pat No. 3,189,662, U.S. Pat. No. 3,821,325, and U.S. Pat. No. 3,832,419.

Preferred polydiorganosiloxane-polycarbonate block copolymers may be prepared, for example, by reacting polydiorganosiloxanes containing α,ω-bishydroxyaryloxy end groups together with other bisphenols, optionally with the concomitant use of branching agents in the conventional amounts, for example according to the two-phase boundary process (as described, for example, in H. Schnell, “Chemistry and Physics of Polycarbonates”, Polymer Reviews, Volume 9, p. 31-76, Interscience Publishers, New York, London, Sydney, 1964). The polydiorganosiloxanes containing α,ω-bishydroxyaryloxy end groups used as starting materials for that synthesis, and their preparation, are described, for example, in U.S. Pat. No. 3,419,634.

Conventional additives, such as, for example, release agents, may be added to the polycarbonates of component C) in the melt or be applied to the surface thereof. The polycarbonates used preferably already contain release agents before they are compounded with the other components of the molding compositions according to the invention.

According to the invention, the compositions contain as component D) an elastomeric polymer having a glass transition temperature below −5° C., preferably below −15° C., more preferably below −30° C., most preferably below −50° C., or a mixture of two or more different polymers of that type; such polymers are also often referred to as impact modifiers, elastomers or rubbers.

Component D) according to the invention generally comprises copolymers, preferably graft copolymers, of at least two, preferably three, of the following monomers: styrene, acrylonitrile, butadiene, acrylic and methacrylic acid esters of alcohols having from 1 to 18 carbon atoms as the alcohol component, vinyl acetate, ethylene, propylene, 1,3-butadiene, isobutene, isoprene and/or chloroprene. Such polymers of component D) are described, for example, in “Methoden der Organischen Chemie” (Houben-Weyl), Vol. 14/1, Georg Thieme-Verlag, Stuttgart 1961, p. 392-406 and in C. B. Bucknall, “Toughened Plastics”, AppI. Science Publishers, London 1977 (all incorporated by reference herein. In the case of graft copolymers, at least one outer shell is grafted onto a core.

Graft copolymers that are preferably used as component D) are obtained, for example, by the graft reaction of styrene, acrylonitrile and/or methyl methacrylate onto a graft base of 1,3-butadiene, isoprene, n-butyl acrylate, styrene and/or 2-ethylhexyl acrylate, more preferably by the graft reaction of acrylonitrile, styrene and/or methyl methacrylate onto a graft base of 1,3-butadiene, isoprene, n-butyl acrylate, styrene and/or 2-ethylhexyl acrylate.

Special preference is given according to the invention to graft copolymers in which methyl methacrylate or a mixture of methyl methacrylate and styrene is grafted onto a graft base based on 1,3-butadiene or onto a graft base consisting of a mixture of 1,3-butadiene and styrene, which copolymers are also referred to as MBS (methyl methacrylate-butadiene-styrene) rubbers.

There are preferably used as component D) also graft copolymers in which n-butyl acrylate, n-butyl methacrylate, ethyl acrylate, methyl acrylate, 1,3-butadiene, isoprene and/or 2-ethylhexyl acrylate is grafted onto a graft base of 1,3-butadiene, isoprene, n-butyl acrylate, styrene and/or 2-ethylhexyl acrylate.

The monomer mixtures grafted onto the graft base may expressly also include monomers functionalized with additional reactive groups, such as, for example, epoxy or glycidyl, carboxyl, carboxylic anhydride, amino and/or amide groups, and having an ethylenic double bond, such as, for example, acylamide, methacrylamide, (N,N-dimethylamino)ethyl acrylate, preferably maleic acid, fumaric acid, maleic anhydride, allyl glycidyl ether, vinyl glycidyl ether, glycidyl acrylate, glycidyl methacrylate.

According to the invention, crosslinking monomers may also be polymerized into the graft base and/or into outer shells, such as, for example, divinylbenzene, diallyl phthalate, dihydrodicyclopentadiene acrylate and/or 1,3-butadiene.

It is also possible to use so-called graft-crosslinking monomers, which have at least two polymerizable double bonds, the double bonds polymerizing at different rates during the polymerization. Preferably, one double bond polymerizes at approximately the same rate as the other monomers, while the other double bond or bonds polymerize markedly more slowly, resulting in a certain proportion of double bonds in the rubber. During the grafting of a further phase, some of those double bonds are able to react with the graft monomers and accordingly partially bond the grafted phase chemically to the graft base. Examples which may be mentioned in this connection include ethylenically unsaturated carboxylic acid esters, such as allyl acrylate, allyl methacrylate, diallyl maleate, diallyl fumarate, or compounds mentioned in U.S. Pat. No. 4,148,846.

Component D) preferably additionally includes a graft polymer having a graft base based on acrylates having a glass transition temperature below −5° C., preferably below −15° C., more preferably below −30° C., most preferably below −50° C. (such graft polymers are generally referred to as acrylate rubbers), or a mixture of two or more different graft polymers of that type, or an elastic block polymer, especially a two- or three-block copolymer, based on vinyl aromatic compounds and dienes, or a mixture of two or more different elastic block polymers of that type, or mixtures of graft polymers and elastic block polymers.

The above-mentioned acrylate rubbers which may likewise preferably be used as component D) preferably include graft copolymers having elastomeric properties, which are substantially obtainable from at least 2 of the following monomers: (meth)acrylic acid esters having from 1 to 18 carbon atoms in the alcohol component, chloroprene, 1,3-butadiene, isopropene, styrene, acrylonitrile, ethylene, propylene and vinyl acetate, the graft base containing at least one (meth)acrylic acid ester, that is to say polymers such as are likewise described, for example, in “Methoden der Organischen Chemie” (Houben-Weyl), Vol. 14/1, Georg Thieme-Verlag, Stuttgart 1961, p. 393-406 and in C. B. Bucknall, “Toughened Plastics”, Appl. Science Publishers, London 1977.

Preferred polymers D) may be partly crosslinked and may have gel contents of over 5 wt. %, preferably 20 wt. %, more preferably over 40 wt. %, especially over 60 wt. %.

Preferred acrylate rubbers as component D) are graft copolymers containing

D.1) from 95 to 5 wt. %, preferably from 10 to 80 wt. %, based on component D, of graft base based on at least one polymerizable, ethylenically unsaturated monomer as the graft monomers, and

D.2) from 5 to 95 wt. %, preferably from 20 to 90 wt. %, based on component D, of acrylate rubber having a glass transition temperature <−10° C., preferably <−20° C., as the graft base. D.2) may particularly preferably contain polymers of acrylic acid esters or methacrylic acid esters, which may contain up to 40 wt. %, based on D.2), of other ethylenically unsaturated monomers.

The acrylate rubbers according to D.2 are preferably polymers of acrylic acid alkyl esters or methacrylic acid alkyl esters, optionally with up to 40 wt. %, based on D.2, of other polymerizable, ethylenically unsaturated monomers. The preferred acrylic acid esters or methacrylic acid esters include C₁-C₈-alkyl esters, especially methyl, ethyl, butyl, n-octyl and 2-ethylhexyl esters; as well as haloalkyl esters, preferably halo-C₁-C₈-alkyl esters, such as chloroethyl acrylate, as well as mixtures of those monomers.

Acrylic acid alkyl esters and methacrylic acid esters are preferably esters of acrylic acid or methacrylic acid with monohydric alcohols having from 1 to 18 carbon atoms. Special preference is given to methacrylic acid methyl ester, ethyl ester and propyl ester, n-butyl acrylate, tert-butyl acrylate and tert-butyl methacrylate.

Graft monomers of the graft base D.1 are preferably selected from at least one monomer, preferably 2 or 3 monomers, from the group consisting of styrene, α-methylstyrene, styrenes substituted at the nucleus by halogen or by methyl, (meth)acrylic acid C₁-C₈-alkyl esters, acrylonitrile, methacrylonitrile, maleic anhydride, C₁-C₄-alkyl- or phenyl-N-substituted maleimides, or mixtures thereof.

Particularly preferred graft copolymers D) include graft polymers of:

D.1) from 5 to 95 parts by weight, preferably from 10 to 80 parts by weight, especially from 30 to 80 parts by weight, of a mixture of

D.1.1 from 50 to 99 wt. %, preferably from 60 to95 wt. %, methyl methacrylate, styrene, α-methylstyrene, styrenes substituted at the nucleus by halogen or by methyl, or mixtures of those compounds, and

D.1.2 from 1 to 50 wt. %, preferably from 35 to 10 wt. %, methyl methacrylate, acrylonitrile, methacrylonitrile, maleic anhydride, C₁-C₄-alkyl- or phenyl-N-substituted maleimides, or mixtures of those compounds, with

D.2) from 5 to 95 parts by weight, preferably from 20 to 90 parts by weight, especially from 20 to 70 parts by weight, of polymer based on alkyl acrylate having a glass transition temperature below −10° C., preferably below −20° C.,

the sum of the parts by weight of D.1) and D.2) being 100.

Special preference is given to graft copolymers D) that are obtainable by graft reaction of

α from 10 to 70 wt. %, preferably from 15 to 50 wt. %, especially from 20 to 40 wt. %, based on graft polymer D, of at least one (meth)acrylic acid ester or from 10 to 70 wt. %, preferably from 15 to 50 wt. %, especially from 20 to 40 wt. %, of a mixture of from 10 to 50 wt. %, preferably from 20 to 35 wt. %, based on the mixture, of acrylonitrile or (meth)acrylic acid esters and from 50 to 90 wt. %, preferably from 65 to 80 wt. %, based on the mixture, of styrene, as the graft base D.1, with

β from 30 to 90 wt. %, preferably from 50 to 85 wt. %, especially from 60 to 80 wt. %, based on graft copolymer D), of a graft base D.2) which contains from 70 to 100 wt. % of at least one alkyl acrylate having from 1 to 8 carbon atoms in the alkyl radical, preferably n-butyl acrylate and/or methyl-n-butyl acrylate and/or 2-ethylhexyl acrylate, especially n-butyl acrylate, as the sole alkyl acrylate, from 0 to 30 wt. %, preferably from 0 to 15 wt. %, of a further copolymerizable monoethylenically unsaturated monomer, such as butadiene, isoprene, styrene, acrylonitrile, methyl methacrylate or vinyl methyl ether, or mixtures thereof, from 0 to 5 wt. % of a copolymerizable, polyfunctional, preferably bi- and tri-functional, monomer effecting crosslinking, the amounts by weight being based on the total weight of the graft base.

Preferred graft polymers D) based on acrylate rubbers are, for example, bases D.2) grafted with (meth)acrylic acid alkyl esters and/or styrene and/or acrylonitrile. Acrylate rubbers based on n-butyl acrylate are particularly preferred as the graft base D.2).

Particularly preferred graft polymers D) based on acrylate rubbers are especially those which contain less than 5 wt. % polystyrene units, preferably less than 1 wt. % polystyrene units, based on the total weight of the graft, particularly preferably those which contain no polystyrene units.

Component D) may also be a mixture of different graft copolymers.

The gel content of the graft base β is generally at least 20 wt. %, preferably 40 wt. % (measured in toluene), and the degree of grafting G is generally from 0.15 to 0.55.

The mean particle diameter of the graft copolymer of component D) is preferably from 0.01 to 2 μm, more preferably from 0.05 to 1.0 μm, particularly preferably from 0.08 to 0.6 μm, most preferably from 0.1 to 0.4 μm.

The mean particle diameter is determined, for example, on electron microscope images (TEM) of ultra-thin sections of the molding compositions according to the invention, treated with OsO₄ and RuO₄, by measuring a representative amount (approximately 50) of particles.

The mean particle diameter d₅₀, determined by means of ultracentrifugation (W. Scholtan, H. Lange, Kolloid, Z. und Z. Polymere 250 (1972), 782-796), is the diameter above and below which lie 50% of the particles. The mean particle diameter d₅₀ of the graft polymers D) is preferably from 0.1 to 0.6 μm.

The gel content of the graft base D.2 is determined at 25° C. in dimethylformamide (M. Hoffmann, H. Krömer, R. Kuhn, Polymeranalytik I und II, Georg Thieme-Verlag, Stuttgart 1977).

The degree of grafting G denotes the weight ratio of grafted graft monomers to the graft base and is dimensionless.

For crosslinking preferably of the polymers D) based on acrylate rubbers it is possible to copolymerize monomers having more than one polymerizable double bond. Preferred examples of crosslinking monomers are esters of unsaturated monocarboxylic acids having from 3 to 8 carbon atoms and unsaturated monohydric alcohols having from 3 to 12 carbon atoms or saturated polyols having from 2 to 4 OH groups and from 2 to 20 carbon atoms, such as, for example, ethylene glycol dimethacrylate, allyl methacrylate; polyunsaturated heterocyclic compounds, such as, for example, trivinyl and triallyl cyanurate; polyfunctional vinyl compounds, such as di- and tri-vinylbenzenes; but also triallyl phosphate and diallyl phthalate. Preferred crosslinking monomers are allyl methacrylate, ethylene glycol dimethylacrylate, diallyl phthalate and heterocyclic compounds having at least 3 ethylenically unsaturated groups. Particularly preferred crosslinking monomers are the cyclic monomers triallyl cyanurate, triallyl isocyanurate, trivinyl cyanurate, triacryloylhexahydro-s-triazine, triallyl benzenes, acrylic acid esters of tricyclodecenyl alcohol.

The amount of crosslinking monomers is preferably from 0.02 to 5 wt. %, especially from 0.05 to 2 wt. %, based on the graft base D.2.

In the case of cyclic crosslinking monomers having at least 3 ethylenically unsaturated groups, it is advantageous to limit the amount to less than 1 wt. % of the graft base D.2.

The graft polymers D) may be prepared according to known processes, such as mass, suspension, emulsion or mass-suspension processes.

Since it is known that the graft monomers are not necessarily grafted onto the graft base completely in the grafting reaction, graft polymers D) are to be understood according to the invention as meaning also those products which are obtained by polymerization of the graft monomers in the presence of the graft base.

The graft polymers D) are preferably used in compacted form.

Component D) according to the invention also includes block polymers having elastomeric properties, especially, for example, two- (A-B) and three- (A-B-A) block copolymers. Block copolymers of type A-B and A-B-A may exhibit behavior typical of thermoplastic elastomers. The preferred block copolymers of type A-B and A-B-A contain one or two vinyl aromatic blocks (particularly preferably based on styrene) and a rubber block (particularly preferably a diene rubber block, most preferably a polybutadiene block or an isoprene block), which may optionally be partially or completely hydrogenated.

Suitable block copolymers of type A-B and A-B-A are described, for example, in U.S. Pat. Nos.3,078,254, 3,402,159, 3,297,793, 3,265,765 and 3,594,452 and in GB-A 1 264 741. Examples of typical block copolymers of type A-B and A-B-A are: polystyrene-polybutadiene (SBR), polystyrene-poly(ethylene-propylene), polystyrene-polyisoprene, poly(α-methylstyrene)-polybutadiene, polystyrene-polybutadiene-polystyrene (SBR), polystyrene-poly(ethylene-propylene)-polystyrene, polystyrene-polyisoprene-polystyrene and poly(α-methylstyrene)-polybutadiene-poly(α-methylstyrene), as well as hydrogenated versions thereof, such as, for example and preferably, hydrogenated polystyrene-polybutadiene-polystyrene (SEBS) and hydrogenated polystyrene-polyisoprene (SEP). The use of corresponding hydrogenated block copolymers, optionally in admixture with the non-hydrogenated precursor as impact modifier, is described, for example, in DE-A 2 750 515, DE-A 2 434 848, DE-A 038 551, EP-A 0 080 666 and WO-A 83/01254 all are incorporated herein by reference.

Mixtures of the mentioned block polymers may also be used.

Special preference is given to partially or completely hydrogenated block copolymers, with hydrogenated polystyrene-polybutadiene-polystyrene (SEBS) and hydrogenated polystyrene-polyisoprene (SEP) being particularly preferred.

Such block polymers of types A-B and A-B-A are available commercially from a number of sources, such as, for example, from Phillips Petroleum under the trademark SOLPRENE, from Shell Chemical Co. under the trademark KRATON, from Dexco under the trademark VECTOR and from Kuraray under the trademark SEPTON.

The thermoplastic molding compositions contain as component E) a filler and/or reinforcing material or a mixture of two or more different fillers and/or reinforcing materials, for example based on talc, mica, silicate, quartz, titanium dioxide, wollastonite, kaolin, amorphous silica, magnesium carbonate, chalk, feldspar, barium sulfate, glass spheres and/or fibrous fillers and/or reinforcing materials based on carbon fibers and/or glass fibers. Preference is given to the use of particulate mineral fillers based on talc, mica, silicate, quartz, titanium dioxide, wollastonite, kaolin, amorphous silica, magnesium carbonate, chalk, feldspar, barium sulfate. Special preference is given according to the invention to particulate mineral fillers based on talc and/or wollastonite and/or kaolin. Particulate mineral fillers based on talc are most preferred.

In particular for applications requiring isotropy in the case of dimensional stability and high thermal dimensional stability, such as, for example, in motor vehicle applications for exterior automotive body parts, there are preferably used mineral fillers, particularly preferably talc or wollastonite or kaolin, most preferably talc.

When component D) is a block copolymer, the blends contain the mineral filler preferably in an amount of 2.5 to 34 parts by weight, particularly preferably in an amount of 3.5 to 28 parts by weight, most preferably in an amount of 5 to 21 parts by weight.

Needle-shaped mineral fillers are also particularly preferred. According to the invention, a needle-shaped mineral filler is understood as being a mineral filler having a pronounced needle-shaped character. Needle-shaped wollastonites may be mentioned as an example. The mineral preferably has a length:diameter ratio of from 2:1 to 35:1, particularly preferably from 3:1 to 19:1, most preferably from 4:1 to 12:1. The mean particle size of the needle-shaped minerals according to the invention is preferably less than 20 μm, particularly preferably less than 15 μm, especially preferably less than 10 μm, most preferably less than 5 μm, and may be determined using a CILAS GRANULOMETER.

Mineral fillers based on talc are most preferred as component E). Suitable mineral fillers based on talc within the scope of the invention are all particulate fillers that the person skilled in the art associates with talc or talcum. Also suitable are all particulate fillers that are supplied commercially and whose product descriptions contain the terms talc or talcum as characterizing features.

Preference is given to mineral fillers having a talc content according to DIN 55920 of greater than 50 wt. %, preferably greater than 80 wt. %, particularly preferably greater than 95 wt. % and most particularly preferably greater than 98 wt. %, based on the total weight of filler.

The mineral fillers based on talc may also be surface-treated. They may, for example, be provided with an adhesion-promoter system, for example based on silane.

The mineral fillers based on talc according to the invention preferably have an upper particle or grain size d₉₇ of less than 50 μm, preferably less than 25 μm, particularly preferably less than 10 μm and most particularly preferably less than 6 μm. There is chosen as the mean grain size d₅₀ preferably a value of less than 10 μm, preferably less than 6 μm, particularly preferably less than 2 μm and most particularly preferably less than 1 μm. The d₉₇ and d₅₀ values of the fillers D are determined by SEDIGRAPH D 5000 sedimentation analysis or by DIN 66 165 sieve analysis.

The mean aspect ratio (diameter to thickness) of the particulate fillers based on talc is preferably in the range of 1 to 100, particularly preferably 2 to 25 and most particularly preferably 5 to 25, determined on electron microscope images of ultra thin sections of the finished products and measurement of a representative amount (approximately 50) of filler particles.

The filler and/or reinforcing material may optionally be surface-modified, for example with an adhesion promoter or adhesion-promoter system, for example based on silane. Pre-treatment is not absolutely necessary, however. In particular when glass fibers are used, it is possible to use in addition to silanes also polymer dispersions, film-forming agents, branching agents and/or glass fiber processing aids.

Conventional silane compounds for the pre-treatment have, for example, the general formula

(X —(CH₂)_{q})ₖ—Si—(O—CᵣH₂ᵣ₊₁)₄₋ₖ

in which the substituents have the following meanings:

x is

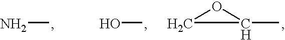

q is an integer from 2 to 10, preferably 3 or 4,

r is an integer from 1 to 5, preferably 1 or 2,

k is an integer from 1 to 3, preferably 1.

Preferred silane compounds are aminopropyltrimethoxysilane, aminobutyltrimethoxysilane, aminopropyltriethoxysilane, aminobutyltriethoxysilane, as well as the corresponding silanes containing a glycidyl group as the substituent X.

The silane compounds are generally used for the surface coating in amounts of from 0.05 to wt. %, preferably from 0.5 to 1.5 wt. % and especially from 0.8 to 1 wt. %, based on the mineral filler.

As a result of the processing to the molding composition or molded body, the fillers in the molding composition or molded body may have a smaller d₉₇ or d₅₀ value than the fillers originally used.

The particle diameters of the finished product may be determined, for example, by recording electron microscope images of thin sections of the polymer mixture and using at least 25, preferably at least 50, filler particles for the evaluation.

The compositions according to the invention may also contain conventional additives, which may add up to 15 wt. %, preferably in an amount of 0.01 to 10 wt. %, particularly preferably 0.05 to 5 wt. %, most particularly preferably 0.1 to 3 wt. %, based on the total weight of the molding compositions.

In addition to components A) to E), the compositions according to the invention may also contain conventional additives, such as, for example, stabilizers (for example, UV stabilizers, thermal stabilizers), antistatics, flow auxiliaries, release agents, fireproofing additives, emulsifiers, nucleating agents, plasticizers, lubricants, pH-lowering additives (e.g. compounds containing carboxyl groups), additives for increasing conductivity, colorants, pigments, etc., as well as mixtures thereof. The mentioned additives and further suitable additives are described, for example, in Gächter, Müller, Kunststoff-Additive, 3rd edition, Hanser-Verlag, Munich, Vienna, 1989. The additives may be used alone or in mixtures or in the form of master batches. The additives may be mixed in and/or applied to the surface.

There may be used as stabilizers preferably sterically hindered phenols and/or phosphites, hydroquinones, aromatic secondary amines, such as diphenylamines, substituted resorcinols, salicylates, benzotriazoles and benzophenones, as well as representatives of those groups carrying various substituents, and mixtures thereof. Stabilizers based on phosphite and/or phosphite ester stabilizers and/or phosphonate and/or phosphonate ester stabilizers are particularly preferred.

There may be used as pigments, for example, titanium dioxide, ultramarine blue, iron oxide, carbon black, phthalocyanines, quinacridones, perylenes, nigrosine and anthraquinones.

There may be used as nucleating agents, for example, sodium phenylphosphinate, aluminum oxide, silicon dioxide and, preferably, talcum and the nucleating agents described above.

There may be used as lubricants and release agents preferably, for example, ester waxes, pentaerythritol stearate (PETS), long-chain fatty acids (e.g. stearic acid or behenic acid), salts thereof (e.g. Ca or Zn stearate), as well as amide derivatives (e.g. ethylene-bis-stearylamide) or montan waxes (mixtures of straight-chain, saturated carboxylic acids having chain lengths of from 28 to 32 carbon atoms) as well as low molecular weight polyethylene or polypropylene waxes.

There may be used as plasticizers preferably phthalic acid dioctyl ester, phthalic acid dibenzyl ester, phthalic acid butylbenzyl ester, hydrocarbon oils, N-(n-butyl)benzenesulfonamide.

In order to obtain conductive molding compositions there may preferably be added, for example, carbon blacks, conductivity carbon blacks, carbon fibrils, nano-scale graphite fibers (nanotubes), graphite, conductive polymers, metal fibers as well as other conventional additives for increasing conductivity.

There may be used as flameproofing agents, for example, commercially available organic halogen compounds with synergists, or commercially available organic nitrogen compounds, or organiclinorganic phosphorus compounds, individually or in a mixture. Mineral flameproofing additives, such as magnesium hydroxide or Ca—Mg-carbonate hydrates (e.g. DE-A 4 236 122), may also be used. Examples of halogen-containing, especially brominated and chlorinated, compounds which may be mentioned include: ethylene 1,2-bistetrabromophthalimide, epoxidised tetrabromobisphenol A resin, tetrabromobisphenol A oligocarbonate, tetrachlorobisphenol A oligocarbonate, pentabromopolyacrylate, brominated polystyrene. Suitable organic phosphorus compounds are the phosphorus compounds according to WO-A 9817720, for example triphenyl phosphate (TPP), resorcinol bis-(diphenylphosphate) including oligomers as well as bisphenol A bis-diphenylphosphate including oligomers (see, for example, EP-A 363 608 and EP-A 640 655), melamine phosphate, melamine pyrophosphate, melamine polyphosphate and mixtures thereof. Suitable nitrogen compounds are especially melamine and melamine cyanurate. There are suitable as synergists, for example, antimony compounds, especially antimony trioxide and antimony pentoxide, zinc compounds, tin compounds, such as, for example, tin stannate, and borates. Carbon-forming agents and tetrafluoroethylene polymers may be added. The flameproofing agents, optionally with a synergist, such as antimony compounds, and antidripping agents are generally used up to an amount of 30 wt. %, preferably 20 wt. % (based on the total composition).

The invention relates also to a process for the preparation of the compositions, to the use of the composition according to the invention in the production of molded articles , molding compositions, semi-finished products and moldings, and to molded articles, molding compositions, semi-finished products and moldings produced therefrom.

The preparation of the compositions according to the invention is carried out according to processes known per se by mixing the components. It may be advantageous to pre-mix individual components. Mixing of components A to E and of further constituents advantageously takes place at temperatures of from 220 to 330° C. by kneading, extruding or rolling the components together.

The compositions according to the invention may be processed according to conventional methods to semi-finished products or moldings of all kinds. Examples of processing methods which may be mentioned include extrusion processes and injection-molding processes. Examples of semi-finished products which may be mentioned include films and sheets.

The moldings may be of small or large size and may be used for exterior or interior applications. Preference is given to the production of moldings of large size for motor vehicle construction, especially for the automotive sector. The molding compositions according to the invention may be used to manufacture especially exterior automotive body parts, such as, for example, wings, tailgates, bonnets, bumpers, load areas, covers for load areas, car roofs or automotive body add-on parts.

Moldings or semi-finished products produced from the molding compositions/compositions according to the invention may also be used in a composite structure with other materials, such as, for example, metal or plastics. After optional lacquering of, for example, exterior automotive body parts, lacquer layers may be located directly on the molding compositions according to the invention and/or on the materials used in the composite structure. The molding compositions according to the invention, or the moldings/semi-finished products produced from the molding compositions according to the invention, may be used in a composite structure with other materials or as they are to produce finished parts, such as, for example, exterior automotive body parts, by conventional techniques of connecting and joining a plurality of components or parts, such as, for example, co-extrusion, spraying the back with a film, spraying around inserts, adhesive bonding, welding, screwing or clamping.

The molding compositions, moldings and/or semi-finished products produced from the compositions according to the invention are preferably used for applications as exterior automotive body parts, in which they pass through or jointly pass through one or more lacquering steps. Special preference is given to applications as exterior automotive body parts in which the molding compositions, moldings and/or semi-finished products according to the invention pass through or jointly pass through one or more lacquering steps, wherein the lacquering and/or the after-treatment includes a step having a temperature load of from 120 to 220° C., preferably from 130 to 200° C., particularly preferably from 140 to 185° C., most preferably from 150 to 170° C., the temperature load acting for a period of more than 5 minutes, preferably more than 10 minutes, particularly preferably more than 15 minutes, most preferably more than 24 minutes. That temperature load may occur, for example, during curing and/or drying of the cathodic dip coating, preferably during curing and/or drying of a filler and/or primer.

The molding compositions, moldings and/or semi-finished products obtained from the compositions according to the invention may, however, be used wherever increased dimensional stability under heat is required, for example in the thermal curing of adhesives, fillers and/or in the after-tempering of molding compositions and/or composite parts.

The molding compositions according to the invention may also be used for numerous other applications. Mention may be made, for example, of their use in electrical engineering, in the construction sector or in data storage. In the mentioned fields of use, moldings produced from the molding compositions according to the invention may be used, for example, as lamp covers, as spools, as safety plates, as casing material for electronic devices, as casing material for domestic appliances, as sheets for the production of coverings.

The compositions according to the invention are distinguished by excellent Vicat B dimensional stability under heat and dimensional stability under heat. The dimensional stability under heat of the composition according to the invention, measured as Vicat B dimensional stability under heat, is in the range of 145° C. to 240° C., preferably in the range of 150° C. to 220° C., particularly preferably in the range of 156° C. to 202° C., most preferably in the range of 160° C. to 185° C. Compositions without a polycarbonate of component B) are preferably distinguished by particularly high Vicat B dimensional stability under heat and dimensional stability under heat.

The compositions according to the invention are also distinguished by excellent dimensional stability and low linear thermal expansion.

Compositions that contain at least one polycarbonate of component C) and at least one polycarbonate of component B preferably exhibit high Vicat B dimensional stability under heat and, at the same time, also very high toughness and impact strength and an unexpectedly small decrease in impact strength at low temperatures, so that they are suitable especially for applications having increased demands as regards dimensional stability under heat in combination with high toughness, such as, for example, for exterior automotive body parts which are lacquered, for example, by the inline lacquering process. In particular, it has also been found that compositions containing at least one MBS rubber as component D) exhibit high Vicat B dimensional stability under heat and particularly high toughness and impact strength and a particularly low fall in impact strength at low temperatures, so that they are suitable especially for the described applications.

The compositions according to the invention additionally fulfil the demands made in respect of processing stability, toughness, low temperature toughness, rigidity, thermal expansion, surface quality, melt flowability, lacquerability, chemical resistance and fuel resistance.

### EXAMPLES

Component A

Polyethylene terephthalate type A1: Polyethylene terephthalate having an intrinsic viscosity IV of 0.74 cm³/g and an isothermal crystallization time at 215° C. of approximately 4.2 minutes.

Polyethylene terephthalate type A2: Polyethylene terephthalate having an intrinsic viscosity IV of 0.78 cm³/g and an isothermal crystallization time at 215° C. of approximately 23.7 minutes.

Polyethylene terephthalate type A3: Polyethylene terephthalate having an intrinsic viscosity IV of 0.64 cm³/g and an isothermal crystallization time at 215° C. of approximately 7.2 minutes.

The intrinsic viscosity is measured in phenol/o-dichlorobenzene (1:1 part by weight) at 25° C.

Determination of the isothermal crystallization time of PET using the DSC method (differential scanning calorimetry) is carried out with a PERKIN ELMER DSC 7 differential scanning calorimeter (weighed portion approximately 10 mg, perforated Al pan) using the following temperature schedule:

1. heating from 30° C. to 290° C. at 40° C./min,

2. 5 min. isothermal at 290° C.,

3. cooling from 290° C. to 215° C. at 160° C./min,

4. 30 min. isothermal at 215° C. (crystallization temperature).

The evaluation software is PE Thermal Analysis 4.00.

Component B

Linear polycarbonate (Makrolon 2805 from Bayer A G, Leverkusen, Germany) based on bisphenol A and having a viscosity ηrel. of 1.29 (measurement conditions: 5 g of polycarbonate per liter of methylene chloride, 25° C.) and a molecular weight M_{w} of 29,000 g/mol. (determined by GPC methods against a polycarbonate standard).

Component C

Linear polycarbonate (Apec HT KU1-9371 from Bayer A G, Leverkusen, Germany) based on bisphenol A and 1,1-bis-(4-hydroxyphenyl)-3,3,5-trimethylcyclohexane as monomers, having a Vicat B dimensional stability under heat of from 203° C. to 206° C. with a viscosity ηrel. of 1.28 (measurement conditions: 5 g of Apec HT KU1-9371 per liter of methylene chloride, 25° C.) and a molecular weight Mw of 33,000 g/mol. (determined by GPC methods against a polycarbonate standard).

Component D

The acrylate graft polymer used in the case of component D1 is Paraloid EXL 2300 from Rohm und Haas Deutschland GmbH, Frankfurt.

The MBS graft polymer (methyl methacrylate-butadiene-styrene) used in the case of D2 is Paraloid EXL 2650 from Rohm und Haas Deutschland GmbH, Frankfurt.

The block copolymers used are Kraton G 1651 (SEBS) in the case of component D3 and Kraton G 1702 (SEP) in the case of D4, from Shell Chemical.

The AES polymers used in the case of component D5 are Blendex WX270 from GE/Ube Cycon.

Component E

E1: Talcum from Incemin AG (Switzerland) having a d₅₀ value of 0.9 μm and a d₉₇ value of less than 5 μm.

E2: A surface-treated wollastonite from Nyco Minerals, Inc. having a diameter:length ratio of 11:1 and a mean particle size of 4 μm, d₁₀ of 1.0 μm and d₉₀ of 20 μm.

E3: A surface-treated wollastonite from Nyco Minerals, Inc. having a diameter:length ratio of 19:1 and a mean particle size of 8 μm, d₁₀ of 2.2 μm and d₉₀ of 50 μm.

E4: A surface-treated wollastonite from Nyco Minerals, Inc. having a diameter:length ratio of 13:1 and a mean particle size of 12 μm, d₁₀ of 3.0 μm and d₉₀ of 75 μm.

E5: A surface-treated wollastonite from Nyco Minerals, Inc. having a diameter:length ratio of 5:1 and a mean particle size of 3 μm, d₁₀ of 0.65 μm and d₉₀ of 8 μm.

E6: An uncoated wollastonite from Nyco Minerals, Inc. having a diameter:length ratio of 5:1 and a mean particle size of 3 μm, d₁₀ of 0.65 μm and d₉₀ of 8 μm.

The d₅₀ and d₉₇ values of the talc mineral E1 used were determined from grain size distribution measurements by Sedigraph 5000 D or DIN 66 165 sieve analysis.

The mean particle size, the d₁₀ and d₉₀ values of the wollastonite minerals E2-E6 used were determined from grain size distribution curves from a CILAS GRANULOMETER.

There were used as additives conventional stabilizers, such as commercially available phosphite and/or phosphite ester stabilizers and/or phosphonate and/or phosphonate ester stabilizers, nucleating agents and release agents.

Compounding was carried out on a ZSK32 twin-shaft extruder (Werner und Pfleiderer) at mass temperatures of from 260 to 312° C.

The test specimens were injection-molded on an Arburg 320-210-500 injection-molding machine at melt temperatures of from 260 to 300° C. and tool temperatures of from 70 to 90° C.

The molding compositions according to the invention were tested according to the following methods:

Vicat B: dimensional stability under heat or dimensional stability under heat according to DIN ISO 306/B 120 in silicone oil.

HDT A: dimensional stability under heat or dimensional stability under heat according to DIN ISO 75-2 method Af.

Izod impact strength: toughness according to ISO 180 method 1 U.

Tensile modulus: rigidity according to DIN/EN/ISO 527-2/1A.

Elongation at tear: extensibility determined according to DIN/EN/ISO 527-2/1A.

Coefficient of linear thermal expansion: determined according to DIN 53 752/B in the indicated temperature range.

MVR: flowability according to DIN/ISO 1133 at 280° C. and 2.16 kg.

The composition and properties of the thermoplastic molding compositions according to the invention will be found in Tables 1 to 6.

Tables 1 to 6 show that the molding compositions according to the invention have excellent dimensional stability under heat/dimensional stability under heat (Vicat B) and exhibit an unexpectedly low fall in impact strength at low temperatures (Izod impact strength). In particular, the Vicat B dimensional stability under heat according to the invention is above 140° C. The surface quality of all batches, evaluated by visual assessment, was very good, which means that the surface is smooth and is very readily lacquerable.

In addition, they fulfil the demands made of thermoplastic molding compositions for large-size exterior automotive body parts in respect of rigidity (tensile modulus), extensibility (elongation at tear), thermal expansion (coefficient of linear thermal expansion), flowability in the melt (MVR) and lacquerability (surface quality).

TABLE 1

| Example | | 1(comp.) | 2 | 3 | 4 |
|---|---|---|---|---|---|
| Polycarbonate, type B | [%] | 48 | 36 | 24 | 16 |
| Polycarbonate, type C | | — | 12 | 24 | 32 |
| Polyethylene terephth- | [%] | 37.2 | 37.2 | 37.2 | 37.2 |
| alate, type A1 | | | | | |
| Rubber, type D1 | [%] | 12 | 12 | 12 | 12 |
| Mineral, type E1 | [%] | 2 | 2 | 2 | 2 |
| Additives | [%] | 0.8 | 0.8 | 0.8 | 0.8 |
| Vicat B | [° C.] | 137 | 148 | 156 | 164 |
| HDT A | [° C.] | 92 | 94 | 99 | 92 |
| Izod impact strength | [kJ/m²] | n.b. | n.b. | 109-n.b. | 73 |
| 23° C. | | | | | |
| Izod impact strength | [kJ/m²] | n.b. | n.b. | 107-n.b. | 61 |
| −10° C. | | | | | |
| Izod impact strength | [kJ/m²] | n.b. | n.b. | 86-n.b. | 80 |
| −20° C, | | | | | |
| Tensile modulus | [MPa] | 2400 | 2400 | 2400 | 2400 |
| Elongation at tear | [%] | 59 | 39 | 18 | 7 |
| MVR (280° C./2.16 | [cm³/10 min] | 18 | 13 | 11 | 9 |
| kg) | | | | | |

n.b. = not broken

TABLE 2

| Example | | 5(comp.) | 6 | 7 | 8 |
|---|---|---|---|---|---|
| Polycarbonate, type B | (%) | 50 | 37.5 | 25 | 18 |
| Polycarbonate, type C | | — | 12.5 | 25 | 32 |
| Polyethylene terephth- | [%] | 27.2 | 27.2 | 27.2 | 27.2 |
| alate, type A | | | | | |
| Rubber,type D1 | [%] | 12 | 12 | 12 | 12 |
| Mineral,type E1 | [%] | 10 | 10 | 10 | 10 |
| Additives | [%] | 0.8 | 0.8 | 0.8 | 0.8 |
| Vicat B | [° C.] | 140 | 149 | 160 | 167 |
| HDT A | [° C.] | 106 | 123 | 118 | 110 |
| Izod impact strength | [kJ/m²] | n.b. | 140-n.b. | 53 | 69 |
| 23° C. | | | | | |
| Izod impact strength | [kJ/m²] | 128-n.b. | 77-n.b. | 99 | 81 |
| −10° C. | | | | | |
| Izod impact strength | [kJ/m²] | 131-n.b. | 111 | 77 | 90 |
| −20° C. | | | | | |
| Tensile modulus | [MPa] | 3200 | 3200 | 3200 | 3200 |
| Elongation at tear | [%] | 22 | 19 | 15 | 8 |
| MVR (280° C./2.16 | [cm³/10 min] | 11 | 7 | 6 | 4 |
| kg) | | | | | |

n.b. = not broken

TABLE 3

| Example | | 9 | 10 | 11 | 12 | 13 | 14 |
|---|---|---|---|---|---|---|---|
| Polycarbonate, type B | [%] | 25 | 25 | 25 | 25 | 25 | 25 |
| Polycarbonate, type C | [%] | 25 | 25 | 25 | 25 | 25 | 25 |
| Polyethylene terephthalate, type A1 | [%] | 27.2 | 27.2 | 27.2 | 27.2 | 27.2 | — |
| Polyethylene terephthalate, type A2 | [%] | | | | | | 27.2 |
| Rubber, type D1 | [%] | 12 | — | — | — | — | 12 |
| Rubber, type D2 | [%] | — | 12 | — | — | — | — |
| Rubber, type D3 | [%] | — | — | 12 | — | — | — |
| Rubber, type D4 | [%] | — | — | — | 12 | — | — |
| Rubber, type D5 | [%] | — | — | — | — | 12 | — |
| Mineral, type E1 | [%] | 10 | 10 | | 10 | 10 | 10 |
| Additives | [%] | 0.8 | 0.8 | 0.8 | 0.8 | 0.8 | 0.8 |
| Vicat B | [° C.] | 161 | 159 | 159 | 156 | 154 | 161 |
| HDT A | [° C.] | 120 | 114 | 119 | 119 | 114 | 118 |
| Izod impact strength 23° C. | [kJ/m²] | 211-n.b. | n.b. | 212-n.b. | 156-n.b. | n.b. | 172-n.b. |
| Izod impact strength −10° C. | [kJ/m²] | 128-n.b. | 158-n.b. | 186-n.b. | 94-n.b. | 114-n.b. | 98-n.b. |
| Izod impact strength −20° C. | [kJ/m²] | 122-n.b. | 199-n.b. | 128-n.b. | 108-n.b. | 115-n.b. | 91-n.b. |
| Tensile modulus | [MPa] | 3300 | 3100 | 3000 | 3100 | 3200 | 3230 |
| Elongation at tear | [%] | 24 | 29 | 25 | 4 | 18 | 18 |
| Coefficient of linear thermal | [10\hat{ }-6/K] | 57/76 | 70/81 | 57/83 | 51/79 | 59/75 | — |
| Expansion (l/t) −20 to 90° C. | | | | | | | |
| MVR (280° C./2.16 kg) | [cm³/10 min] | 4 | 4 | 3 | 5 | 1 | 4 |

l/t = longitudinal/transverse
n.b. = not broken

TABLE 4

| Example | | 15 | 16 | 17 | 18 | 19 | 20 |
|---|---|---|---|---|---|---|---|
| Polycarbonate, type B | [%] | 25 | 24 | 23 | 17 | 16 | 7 |
| Polycarbonate, type C | | 25 | 24 | 23 | 31 | 30 | 43 |
| Polyethylene terephthalate, type A1 | [%] | 27.2 | 26.2 | 25.2 | 26.2 | 25.2 | 21.2 |
| Rubber, type D2 | | 12 | 15 | 18 | 15 | 18 | 18 |
| Mineral, type E1 | [%] | 10 | 10 | 10 | 10 | 10 | 10 |
| Additives | [%] | 0.8 | 0.8 | 0.8 | 0.8 | 0.8 | 0.8 |
| Vicat B | [° C.] | 159 | 156 | 156 | 162 | 159 | 169 |
| HDT A | [° C.] | 117 | 113 | 115 | 119 | 113 | 129 |
| Izod impact strength 23° C. | [kJ/m²] | 172-n.b. | n.b. | n.b. | 166-n.b. | 149-n.b. | 173-n.b. |
| Izod impact strength −10° C. | [kJ/m²] | 157 | 171-n.b. | n.b. | 141-n.b. | 127-n.b. | 67-n.b. |
| Izod impact strength −20° C. | [kJ/m²] | 129-n.b. | 178-n.b. | 170-n.b. | 133-n.b. | 116-n.b. | 58-n.b. |
| Tensile modulus | [MPa] | 3190 | 3010 | 2880 | 3030 | 2830 | 2820 |
| Elongation at tear | [%] | 31 | 30 | 34 | 26 | 27 | 23 |
| Coefficient of linear thermal | [10\hat{ }-6/K] | 68/83 | 63/84 | 69/90 | 64/86 | 67/95 | — |
| expansion (l/t) −20 to 90° C. | | | | | | | |
| MVR (280° C./2.16 kg) | [cm³/10 min] | 3 | 3 | 2 | 2 | 2 | 1 |

l/t = longitudinal/transverse
n.b. = not broken

TABLE 5

| | | | | | |
|---|---|---|---|---|---|
| Example | 21 | 22 | 23 | 24 | 25 |

| | | | | | | |
|---|---|---|---|---|---|---|
| Polycarbonate, type B | [%] | 25 | 25 | 25 | 25 | 25 |
| Polycarbonate, type C | [%] | 25 | 25 | 25 | 25 | 25 |
| Polyethylene terephthalate, type A1 | [%] | 27.2 | 27.2 | 27.2 | 27.2 | 27.2 |
| Rubber, type D2 | [%] | 12 | 12 | 12 | 12 | 12 |
| Mineral, type E2 | [%] | 10 | — | — | — | — |
| Mineral, type E3 | [%] | — | 10 | | — | — |
| Mineral, type E4 | [%] | — | — | 10 | | — |
| Mineral, type E5 | [%] | — | — | — | 10 | — |
| Mineral, type E6 | [%] | — | — | — | — | 10 |
| Additives | [%] | 0.8 | 0.8 | 0.8 | 0.8 | 0.8 |
| Vicat B | [° C.] | 152 | 153 | 154 | 153 | 155 |
| HDT A | [° C.] | 106 | 110 | 110 | 105 | 104 |
| Izod impact strength 23° C. | [kJ/m²] | 91 | 137 | 85 | 209 | n.b. |
| Izod impact strength −10° C. | [kJ/m²] | 73 | 116 | 81 | 146 | n.b. |
| Izod impact strength −20° C. | [kJ/m²] | 63 | 97 | 79 | 132 | n.b. |
| Tensile modulus | [MPa] | 3390 | 3410 | 3250 | 3750 | 2700 |
| Elongation at tear | [%] | 18 | 18 | 18 | 27 | 21 |
| Coefficient of linear thermal | [10\hat{ }-6/K] | 56/91 | 57/95 | 51/85 | 72/88 | 68/83 |
| expansion (l/t) from −20 to 90° C. | | | | | | |
| MVR (280° C./2.16 kg) | [cm³/10 min] | 4 | 5 | 6 | 5 | 5 |

l/t = longitudinal/transverse
n.b. = not broken

TABLE 6

| Example | | 26 comp. | 27 |
|---|---|---|---|
| Polycarbonate, type B | [%] | 50 | — |
| Polycarbonate, type C | [%] | — | 50 |
| Polyethylene terephthalate, type A3 | [%] | 27.1 | 27.1 |
| Rubber, type D1 | [%] | 12 | 12 |
| Mineral, type E1 | [%] | 10 | 10 |
| Additives | [%] | 0.9 | 0.9 |
| Vicat B | [° C.] | 139 | 181 |
| HDT A | [° C.] | 108 | 110 |
| Izod impact strength 23° C. | [kJ/m²] | n.b. | 62 |
| Tensile modulus | [MPa] | 3100 | 3160 |
| Elongation at tear | [%] | 30 | 4.5 |
| Coefficient of linear thermal | [10\hat{ }−6/K] | 80/68 | 58/79 |
| expansion (l/t) −20 to 90° C. | | | |
| MVR (280° C./2.16 kg) | [cm³/10 min] | 16 | 5 |

l/t = longitudinal/transverse
n.b. = not broken

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic molding composition containing
A) 4 to 80 parts by weight of at least one polyethylene terephthalate,
B) 0 to 50 parts by weight of at least one aromatic polycarbonate the molecular structure of which contains no units derived from dihydroxydiarylcycloalkanes,
C) 10 to 90 parts by weight of at least one polycarbonate the molecular structure of which includes at least one unit derived from dihydroxydiarylcycloalkane,
D) 1.5 to 35 parts by weight of at least one elastomeric polymer,
E) 1.5 to 54 parts by weight of at least one filler and/or reinforcing material.

2. The composition according to claim 1 wherein B) is present in an amount of 3 to 50 parts by weight.

3. The composition according to claim 1 wherein C) includes at least one unit derived from dihydroxydiphenyl cyclohexane.

4. The composition according to claim 1 wherein C) is a copolycarbonate derived from 1,1-bis-(4-hydroxyphenyl)-3,3,5-trimethylcyclohexane and bisphenol A.

5. The composition according to claim 1 wherein B) is a polycarbonate based on bisphenol A and where C) is a copolycarbonate derived from 1,1-bis-(4-hydroxyphenyl)-3,3,5-trimethylcyclohexane and bisphenol A.

6. The composition according to claim 1 wherein E) is a mineral filler in particulate form.

7. The compositions according to claim 1 wherein E) is a mineral filler based on talc.

8. The composition according to claim 1 wherein D) is present in an amount of 3 to 25 parts by weight.

9. The composition of claim 8 wherein D) is an elastomeric graft copolymer.

10. The composition according to claim 1 wherein D) is a graft polymer based on a methyl methacrylate-butadiene-styrene rubber.

11. The composition according to claim 1 wherein D is a graft polymer having a graft base selected from the group consisting of acrylate having a glass transition temperature below −5° C. and elastomeric block polymer based on at least one vinyl aromatic compound and diene.

12. The composition according to claim 1 wherein D) is a graft polymer containing a grafted phase D.1) and graft base D.2) wherein
D.1) is 95 to 5% relative to the weight of D) and is polymerized from at least one ethylenically unsaturated monomer, and
D.2) is 5 to 95% relative to the weight of D) and is an acrylate rubber having a glass transition temperature <−10° C.

13. The composition according to claim 1 wherein D) is a block copolymer having two or three blocks.

14. The compositions according to claim 1 characterized in having Vicat B temperature that is above 145° C. and below 220° C.

15. A method of using the composition according to claim 1 comprising producing a molded article.

16. The molded article prepared by the method of claim 15.

17. An exterior automotive body part comprising the composition of claim 1.
